(19) United States
(12) Patent Application Publication
(10) Pub. No.: US 2014/0100152 A1
(43) Pub. Date: Apr. 10, 2014

(54) Coated Bleach Materials

(71) Applicants: Kai Heppert, Ludwigshafen (DE); Jörg Pflug, Ludwigshafen (DE); Claudia Schmaelzle, Ludwigshafen (DE)

(72) Inventors: Kai Heppert, Ludwigshafen (DE); Jörg Pflug, Ludwigshafen (DE); Claudia Schmaelzle, Ludwigshafen (DE)

(73) Assignee: RECKITT BENCKISER N.V., Hoofddorp (NL)

(21) Appl. No.: 13/988,071

(22) PCT Filed: Nov. 18, 2011
(86) PCT No.: PCT/GB2011/052252

§ 371 Date: Jul. 9, 2013

(30) Foreign Application Priority Data
Nov. 19, 2010 (GB) 1019623.6

(51) Int. Cl. C11D 3/39

(52) U.S. Cl. CPC C11D 3/394
USPC 510/224; 510/220; 252/186.25; 427/214

(57) ABSTRACT

The invention relates to particles of bleach material that comprise at least two coating layers. At least one of the coating layers comprises a sugar compound and at least one other coating layer comprises a polymer. The invention also relates to detergent compositions containing the coated particles.

### FIELD OF THE INVENTION

The invention relates to coated bleach particles for use in detergent compositions. The particles have at least two coating layers, to improve storage stability and provide a good dissolution profile when used in detergent compositions.

### BACKGROUND TO THE INVENTION

It is well known in the art to formulate bleaching materials in particulate form for use in detergent formulations. This is because particles are considered a convenient form for storage and for the handling of the often sensitive bleaching materials. The particles are particularly suited for inclusion in many detergent compositions.

In order to obtain good cleaning performance on bleachable stains, e.g. tea, it is desirable to include a bleach material in detergent compositions which are to be used to remove such stains. In dishwashing, especially automatic dishwashing it is well recognised that performance on bleachable stains is one of the key attributes by which consumers assess the effectiveness of a detergent compositions. However, it is well known in the art that the presence of a bleach material in a detergent composition can lead to instability of the composition especially when bleach-sensitive ingredients such as enzymes and perfumes are present. Furthermore the bleach material is generally susceptible to stability problems e.g. when in contact with moisture and/or above ambient temperatures which can typically result in a loss of performance of the bleach material.

It has been attempted to address the above problems of stability of the bleaching material/other ingredients and address the resultant loss in performance of the detergent composition by producing granules or particles comprising the bleaching material and coating them with a coating material.

EP-A-1,735,422 and EP-A-1,735,423 discloses a coated bleaching agent particle consisting of a core containing a bleaching active ingredient, especially a peroxocarboxylic acid, with a coat of water soluble material surrounding this core (such as PVOH).

EP-A-1,633,468 discloses a method for preparing capsules containing at least one imidoperoxycarboxylic acid by applying an inorganic salt onto the at least one imidoperoxycarboxylic acid in particulate form so that the salt forms a capsule shell around the acid.

EP-A-1,633,471 discloses a method for preparing multi-layer capsules containing at least one peroxocarboxylic acid (especially imidoperoxycarboxylic acid) by applying at least two different coating layers each based on at least one polyelectrolyte and/or ionic surfactant.

WO 2004/081161 discloses bleach (PAP) encapsulated with a water soluble coating such as gelatin. This bleach containing capsule is disclosed in combination with a liquid composition inside a water soluble outer container.

Encapsulating bleach materials, as described above, to reduce interaction with bleach sensitive materials so as to maintain performance on bleachable stains provides advantages for stability and performance but can still be improved upon. In particular the dissolution time of the particles has a tendency to increase with the use of coating layers.

This increase in dissolution time can be detrimental to cleaning performance. If the dissolution time is too long, then the bleach material is not released into the wash soon enough to carry out effective bleaching.

In particular, it is an object of the present invention to provide particulate material and shaped bodies comprising a bleach material which show good stability and performance of the bleach material coupled with good dissolution properties thereof.

It is a further object of the present invention to provide bleach material which can be readily handled on an industrial scale and which can readily be formed into shaped bodies. In particular such materials which exhibit good solubility characteristics when in use in a washing process are desired.

### SUMMARY OF THE INVENTION

It has surprisingly been found that one or more of the above problems are addressed by the present invention.

Thus according to the present invention there is provided, a particle comprising a bleach material wherein the particle has at least two different coatings and wherein at least one of the coatings comprises a sugar compound and at least one other coating comprises a polymer.

### DETAILED DESCRIPTION OF THE INVENTION

The term particle as used by the present invention may cover a wide range of different sizes. The term particle is broad enough to encompass a large range of sizes. The term particle can encompass compressed pills, pellets and tablets.

The particles of the present invention may be in the range of from 20 microns to 20,000 microns (average mean size), more preferably 200 microns to 15,000 microns, most preferably 500 microns to 10,000 microns, such as 1000 microns to 5000 microns.

If small particles are to be used, then preferably these particles will be spheronized, to form particles of regular shape. This aids the coating step, as regular shapes are simpler to coat.

Any method known in the art to produce particulates may be used for the purposes of the present invention. For example, the mixture of bleach material and other ingredients may be compacted to form pellets, or pressed to form compressed particles.

The bleach material particle may be in the form of a powder or granular material depending upon its particle size. The bleach material particles of the invention may be of any suitable size.

Unless stated otherwise, all amounts herein are given as the percentage by weight of active ingredient based upon the weight of the total composition or the total particle as the context requires.

The term ‘co-granulate’ as used herein includes any particle wherein the stated ingredients are held together in that particle. This includes particles produced by agglomeration, granulation, extrusion and spheronization, pelletizing, fluidized bed and spray-drying.

Without wishing to be bound by theory, the at least two coating method provides excellent results as each layer can be optimized to a different purpose. In the present invention, the sugar layer has been found to provide excellent stability to the bleach material in isolation. The polymer layer has been found to give stability to the sugar coated particle in detergent compositions.

This is particularly important in gel or liquid detergent compositions but it is also advantageous in solid detergent formulations.

### Bleach Compounds

The bleach material may be selected from any conventional bleach material known to be used in detergent compositions. The bleach material preferably comprises at least one inorganic peroxide or organic peracid or a chlorine based bleach including derivatives and salts thereof or mixtures thereof. Most preferred according to the invention are organic peracids and their derivatives/salts.

If at least one inorganic peroxide is used as the bleach material it preferably comprises a percarbonate, perborate and persulphate and/or hydrogen peroxide including derivatives and salts thereof and mixtures thereof. The sodium and potassium salts of these inorganic peroxides being most preferred, especially the sodium salts. Sodium percarbonate and sodium perborate are most preferred, especially sodium percarbonate.

It is especially preferred according to the present invention that the bleach material comprises at least one organic peracid including derivatives and salts and mixtures thereof. These bleach materials are effective at relatively low temperatures, typically around 30° C. and so do not require the use of a bleach activator or bleach catalyst to boost the bleaching performance. This makes these bleach materials especially preferred for detergent applications on environmental and cost considerations.

Organic peracids suitable according for use in the present invention includes all organic peracids traditionally used as bleaches in detergent compositions. Preferred examples include perbenzoic acid and peroxycarboxylic acids especially mono- or diperoxyphthalic acid, 2-octyldiperoxysuccinic acid, diperoxydodecanedicarboxylic acid, diperoxy-azelaic acid, 6-phthalimidoperhexanoic acid (PAP) and imidoperoxycarboxylic acid and the derivatives and salts and mixtures thereof. Especially preferred is 6-phthalimidoperhexanoic acid (PAP) and its derivatives and salts and mixtures thereof.

A preferred form of PAP is supplied by Solvay Chemicals, Inc., and sold under the Eureco WM1 trade mark. This material is 70% PAP by weight. The remainder of the material is made up of inert stabilizing compounds.

The bleach material may be used in a pure form but it is usually commercially available as a raw material which is a mixture of the bleach active material with carrier materials or other auxiliaries such as suitable compatible materials such as stabilisers for the bleach and fillers. Suitable stabilising materials include materials which are capable of taking up water, e.g. as water of crystallisation, such as sulphates.

The bleach material is treated to form particles. This may be via granulation, compaction or extrusion followed by spheronization of the extrudate.

The bleach material can be formed into particles formed solely of the bleach material, or the bleach material may be mixed with other ingredients prior to particulate formation. The bleach material may be supplied already with other ingredients to provide additional stability or other desirable properties.

The bleach material may be mixed with binders or disintegrants, or a mixture thereof.

The bleach material may also be mixed with further optional ingredients as required.

The bleach material may comprise a single type of bleach compound, or alternatively, the bleach material may comprise two or more different bleach compounds.

Binders may be used to ensure that the particles can be formed with required mechanical strength, and give volume to low active dose tablets. Any binder that is compatible with the bleaching material may be used to form the particles of the present invention.

A non-limiting list of suitable binders include, saccharides and their derivatives, disaccharides such as sucrose, lactose, polysaccharides and their derivatives: starches, cellulose or modified cellulose such as microcrystalline cellulose and cellulose ethers such as hydroxypropyl cellulose (HPC); Sugar alcohols such as xylitol, sorbitol or maltitol; proteins such as gelatin; and synthetic polymers: polyvinylpyrrolidone (PVP), polyethylene glycol (PEG) and polyvinylalcohol (PVOH).

Particularly preferred binders comprise the group of non reducing sugars. A particularly preferred non reducing sugar to use as a binder for inclusion in the particle of the present invention is Isomalt (6-O-α-D-Glucopyranosyl-D-sorbitol (1,6-GPS)+1-O-α-D-Glucopyranosyl-D-mannitol dehydrate (1,1-GPM).

A particularly preferred source of Isomalt is sold by BENEO Palatinit under the trade name of GalenIQ 800.

A single binder compound may be used, or alternatively a mixture of two or more different binder compounds may be used to form the particles.

If the binder is used, preferred weight ratios of bleach material:binder in the particles are, 97.5:2.5 to 60:40. Preferably the ratio of bleach material:binder is between 95:5 and 80:20, more preferably between 92:8 and 80:20, by weight. These ratios are for the total weight of binder and bleach material, in the event that two or more binders or bleach materials are used.

Or alternatively the binder may be present within the particle from 2.5 to 40% by weight of particle, preferably from 3 to 30% by weight, more preferably from 5 to 25% by weight and more preferably from 7 to 20% by weight. These weight ratios are for the total weight of binder present, if two or more binders are used.

Disintegrants may be used to ensure that the particles formed have the desired solubility profile.

Non-limiting examples of disintegrants include cross-linked polymers such as cross-linked polyvinylpyrrolidone (crospovidone) and cross-linked sodium carboxymethyl cellulose (croscarmellose sodium). Other disintegrants include the modified starch, sodium starch glycolate, cellulose (e.g. cellulose microcrystalline) and cellulose derivates like Carboxymethylcellulose, hydroxypropyl cellulose, hydroxypropylmethyl cellulose, methyl cellulose.

Polysaccharides can also make effective disintegrants. A particularly preferred disaccharide for use in the present invention is the soy saccharide EMcosoy STS IP from Rettenmaier (JRS).

A single disintegrant compound may be used, or alternatively a mixture of two or more different disintegrant compounds may be used to form the particles.

The disintegrant may be present between 1 and 20% by weight of the particle. Preferably the disintegrant may be present between 2 and 10% by weight of the particle. In the case that two or more disintegrants are used. These weight percentages apply to the total amount of disintegrant.

If a binder and a disintegrant are used with a bleaching material to form the particles of the present invention, the preferred weight ratios of bleach material:binder:disintegrants are 95:2,5:2,5, 90:5:5, 85:10:5, 85:5:10, 75:20:5, 75:15:10, 70:20:10 and 60:30:10. Particularly preferred weight ratios are 85:10:5, 90:5:5, and 90:7.5:2.5.

Other optional ingredients may also be included in the particles as required. The other ingredients used may be any component found within detergent compositions, especially those used for automatic machine washing. Optional ingredients are discussed in more detail below. Optional ingredients may be present in an amount of between 1-10% by weight of the particle.

Any method known in the art to produce particulates may be used for the purposes of the present invention. For example, the mixture of bleach material and other ingredients may be granulated, or compacted to form pellets, or extruded and then broken up. In particular, if extrudates are formed, it is preferably to spheronize the extrudate. This is because this forms very regular particles that are easier to coat.

The bleach material particle may be in the form of a powder or granular material depending upon its particle size. The bleach material particles of the invention may be of any suitable size.

The term particle as used by the present invention may cover a wide range of different sizes. The term particle is broad enough to encompass a large range of sizes. The term particle can encompass compressed pills, pellets and tablets.

The particles of the present invention will be in the range of from 20 microns to 20,000 microns (average mean size), more preferably 200 microns to 15,000 microns, most preferably 500 microns to 10,000 microns, such as 1000 microns to 5000 microns.

If small particles are to be used, then preferably these particles will be spheronized, to form particles of regular shape. This aids the coating step, as regular shapes are simpler to coat.

### Coatings

The particles of the present invention comprise at least two different coating layers.

In the present invention, the term coating means that the surface of the particle is at least substantially covered by the coating layer. In the case of the second of the at least two coating layers, the first coating layer of the particle is at least substantially covered by the second coating layer. For the purposes of the present invention, the term “substantially covered” means that at least 95% of the surface of the particle layer and first coating respectively are covered by the first coating and second coating respectively.

Preferably by “coating” it is meant that the surface of the particle is entirely covered in one coating layer and a second layer entirely covers the particle and the first coating. That 100% of each surface is covered by the coating layer.

If a third or more coating layers are applied, they may also be substantially covering the previous coating layers.

At least one of the coating layers will comprise a sugar compound. At least one other coating layer will comprise a polymer.

The sugar coating layer may comprise between 2 and 60% of the total weight of the bleach particles of the present invention. Preferably the coating comprises between 5 and 50% by weight, more preferably between 10 and 40% by weight and most preferably between 10% and 25% by weight of the bleach particles.

The at least one sugar coating layer of the present invention may be formed from any sugar compound. The sugar may be a mono saccharide, disaccharide or a polysaccharide. The sugar used may be a single pure sugar or a combination of two or more different sugars.

It is particularly preferable to use the sugar mannitol, or a combination of mannitol and other sugars. A particularly preferred source of mannitol is sold by Cargill under the tradename of C*Mannidex.

The coating may consist essentially of the just the sugar compound or compounds. The coating may also contain other ingredients and additives.

The coating may be at least 60% by weight sugar, preferably at least 70% by weight sugar, more preferably at least 80% by weight sugar and most preferably at least 90% by weight sugar.

Preferably the sugar coating layer is the not the outer coating layer. Preferably the sugar coating layer is the, or an, inner coating layer.

The at least one other coating comprises a polymer.

Non-limiting examples of suitable polymers for this additional coating layer include polyvinylalcohol (PVOH), polyvinylacetate (PVA), methacrylate copolymers, polyacrylates, polyacrylate copolymers, PEGs, povidone, hydroxypropylmethylcellulose, carboxymethylcellulose, hydroxypropylcellulose, microcrystalline cellulose and polysaccharrides.

The polymer coating may comprise between 2 and 60% of the total weight of the bleach particles of the present invention. Preferably the polymer coating comprises between 5% and 50% by weight, more preferably between 10% and 40 % by weight and most preferably between 10% and 25% by weight of the bleach particles.

It is particularly preferable to use the polymer polyvinyl acetate (PVA) or polyvinyl alcohol (PVOH) or a combination of PVOH and PVA. Alternatively PVOH or PVA may be combined with one or other polymers.

The coating may consist essentially of the just the polymer compound or polymer compounds. The coating may also contain other ingredients and additives.

The polymer coating may be at least 60% by weight polymer, preferably at least 70% by weight polymer, more preferably at least 80% by weight polymer and most preferably at least 85% by weight polymer.

It is preferable that the polymer coating comprises the outermost layer of the coatings.

It is preferred that the polymer coating layer contains additives to aid the solubility of the particle.

The additives may be selected from the group comprising disintegrants. There may be a single additives or a combination of two or more different additives.

Preferred disintegrants are cross-linked polymers such as cross-linked polyvinylpyrrolidone (crospovidone) and cross-linked sodium carboxymethyl cellulose (croscarmellose sodium). Other disintegrants include polyvinylpyrrolidone (PVP, povidone) and the modified starch, sodium starch glycolate, cellulose (e.g. cellulose microcrystalline) and cellulose derivates like Carboxymethylcellulose, hydroxypropyl cellulose, hydroxypropylmethyl cellulose, methyl cellulose.

A particularly preferred polyvinylpyrrolidone is Kolllidon 30 (supplied by BASF).

A particularly preferred polyvinylacetate (PVAc) polymer coating layer of the present invention includes the additives TEC (triethyl citrate) and polyvinylpyrrolidone (PVP). Preferred compositions of these additives comprise 1-95% by weight PVAc, 1-10% by weight TEC and 1-10% by weight PVP. A particularly preferred polymer coating layer comprises a weight ratio of PVAc:PVP:TEC of 88:10:2.

It is believed that these disintegrant additives form hydrophilic pores within the polymer coating. Without wishing to be bound by theory, these pores allow more rapid solubility of the bleach particles in dilute aqueous solutions while still maintaining a high level of stability on storage in concentrated detergent compositions.

Other non limiting examples of additives include plasticisers like triethylcitrate, pentaerythritols, sorbitol, mannitol, glycerine and glycols such as glycerol, ethylene glycol and polyethylene glycol.

The total amount of additive present in the polymer coating layer is between 0.5% and 40% by weight of the polymer coating layer, more preferably between 1% and 25% by weight, more preferably between 2.5% and 20% by weight and most preferably between 5% and 15% by weight.

### Methods of Preparing the Particles of the Present Invention

The bleach material particles may be produced by any suitable co-granulation technique. Such techniques are well known in the art and do not require further description here but include agglomeration, granulation, extrusion and spheronization, pelletizing, fluidized bed and spray-drying. It is within the ability of the person skilled in the art to be able to adjust the co-granulation technical parameters to produce the co-granulates of the first aspect of the invention.

The bleach particle granules may be coated directly with the coating layers of the present invention. Or the bleach particle granules may be compacted together to form larger particles first, prior to the addition of the coatings. The size of particles coated can range considerably depending on the size desired.

The bleach material particles may also be produced by direct compaction of the bleach material into pellets. The bleach material may be mixed with additives such as binders, disintegrants etc, prior to the compaction process. The pellets may also vary considerably in size depending on the desired end purpose.

Another method that may be used to generate the particles of the present invention is extrusion. The bleach material and any desired additives may be mixed together with a solvent to form a paste. The preferred solvent is water. This paste is then extruded and dried. The extrudate may be broken up into the particles of the desired size.

If the extrudate process is used, it is highly preferably to spheronize the extrudate. This is preferable as regular even shaped particles are easier to coat than irregular ones.

Other methods of preparing particles may be used by the skilled person. The invention is not limited to the methods discussed above.

The application of the at least two coating layers may also be carried out by a variety of methods, known in the art. Including, direct spraying techniques, fluidized bed coating, pan coating, powder coating and compression coating.

The preferred coating method for particles of the present invention is fluidized bed coating. The particularly preferred coating process is the Wurster process.

### Detergent Compositions Comprising the Particles

The particles of the present invention are particularly suitably for use in detergent compositions. In particular, the particles of the present invention are suitable for detergent compositions used in automatic cleaning machines. These include both laundry cleaning and tableware cleaning machines.

The detergent composition may take any form known in the art. Possible forms include tablets, powders, gels, pastes and liquids. The detergent compositions may also comprise a mixture of two or more forms. For example the composition may comprise a gel component and a free powder component. The particles of the present invention may be contained within the gel portion or the powder portion of the detergent composition, or contained within both portions.

Tablets may be homogeneous of composed of multi-layers. If the tablets are multi-layered then different layers may comprise different parts of the detergent composition. This may be done to increase stability or increase performance, or both. The particles of the present invention may be contained within one or more layers of the tablets.

The detergent compositions may be housed in PVOH rigid capsules or film blisters. These PVOH capsules or blisters may have a single compartment or may be multi-compartment.

Multi-compartment blisters or capsules may have different portions of the composition in each compartment, or the same composition in each compartment. The distinct regions/or compartments may contain any proportion of the total amount of ingredients as desired.

The PVOH capsules or film blisters may be filled with tablets, powders, gels, pastes or liquids, or combinations of these.

The detergent compositions may comprise any ingredients known in the art. These may include components such as builders, The builder may be either a phosphorous-containing builder or a phosphorous-free builder as desired.

If phosphorous-containing builders are also to be used it is preferred that mono-phosphates, di-phosphates, tri-polyphosphates or oligomeric-polyphosphates are used. The alkali metal salts of these compounds are preferred, in particular the sodium salts. An especially preferred builder is sodium tripolyphosphate (STPP). Conventional amounts of the phosphorous-containing builders may be used typically in the range of from 15% by weight to 60% by weight, such as from 20% by weight to 50% by weight or from 25% by weight to 40% by weight.

If a phosphorous-free builder is included it is preferably chosen from amino acid based compounds and/or succinate based compounds. The terms ‘succinate based compound’ and ‘succinic acid based compound’ are used interchangeably herein. Conventional amounts of the amino acid based compound and/or succinate based compound may be used typically in the range of from 05% by weight to 80% by weight, such as from 15% by weight to 70% by weight or from 20% by weight to 60% by weight.

Preferred examples of amino acid based compounds which may be used are MGDA (methyl-glycine-diacetic acid, and salts and derivatives thereof) and GLDA (glutamic-N,N-diacetic acid and salts and derivatives thereof). Other suitable builders are described in U.S. Pat. No. 6,426,229 which are incorporated by reference herein. Particular suitable builders include; for example, aspartic acid-N-monoacetic acid (ASMA), aspartic acid-N,N-diacetic acid (ASDA), aspartic acid-N-monopropionic acid (ASMP), iminodisuccinic acid (IDA), N-(2-sulfomethyl) aspartic acid (SMAS), N-(2-sulfoethyl)aspartic acid (SEAS), N-(2-sulfomethyl)glutamic acid (SMGL), N-(2-sulfoethyl)glutamic acid (SEGL), N-methyliminodiacetic acid (MIDA), α-alanine-N,N-diacetic acid (α-ALDA), β-alanine-N,N-diacetic acid (β-ALDA), serine-N,N-diacetic acid (SEDA), isoserine-N,N-diacetic acid (ISDA), phenylalanine-N,N-diacetic acid (PHDA), anthranilic acid-N,N-diacetic acid (ANDA), sulfanilic acid-N,N-diacetic acid (SLDA), taurine-N, N-diacetic acid (TUDA) and sulfomethyl-N,N-diacetic acid (SMDA) and alkali metal salts or ammonium salts thereof.

Further preferred succinate compounds are described in U.S. Pat. No. 5,977,053 and have the formula;

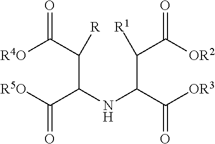

in which R, R¹, independently of one another, denote H or OH, R², R³, R⁴, R⁵, independently of one another, denote a cation, hydrogen, alkali metal ions and ammonium ions, ammonium ions having the general formula R⁶ R⁷ R⁸ R⁹ N+ and R⁶, R⁷, R⁸, R⁹, independently of one another, denoting hydrogen, alkyl radicals having 1 to 12 C atoms or hydroxyl-substituted alkyl radicals having 2 to 3 C atoms.

Preferred examples include tetrasodium imminosuccinate. Iminodisuccinic acid (IDS) and (hydroxy)iminodisuccinic acid (HIDS) and alkali metal salts or ammonium salts thereof are especially preferred succinate based builder salts.

It is especially preferred according to the present invention that the builder comprises methyl-glycine-diacetic acid, glutamic-N,N-diacetic acid, tetrasodium imminosuccinate, or (hydroxy)iminodisuccinic acid and salts or derivatives thereof.

The phosphorous-free builder may also or alternatively comprise non-polymeric organic molecules with carboxylic group(s). Builder compounds which are organic molecules containing carboxylic groups include citric acid, fumaric acid, tartaric acid, maleic acid, lactic acid and salts thereof. In particular the alkali or alkaline earth metal salts of these organic compounds may be used, and especially the sodium salts. An especially preferred phosphorous-free builder is sodium citrate. Such polycarboxylates which comprise two carboxyl groups include, for example, water-soluble salts of, malonic acid, (ethylenedioxy)diacetic acid, maleic acid, diglycolic acid, tartaric acid, tartronic acid and fumaric acid. Such polycarboxylates which contain three carboxyl groups include, for example, water-soluble citrate. Correspondingly, a suitable hydroxycarboxylic acid is, for example, citric acid.

Preferably the total amount of builder present is an amount of at least 20% by weight, and most preferably at least 25% by weight, preferably in an amount of up to 70% by weight, preferably up to 65% by weight, more preferably up to 60% by weight. The actual amount used in the compositions will depend upon the nature of the builder used. If desired a combination of phosphorous-containing and phosphorous-free builders may be used.

The shaped body and detergent compositions may optionally further comprise a secondary builder (or cobuilder). Preferred secondary builders include homopolymers and copolymers of polycarboxylic acids and their partially or completely neutralized salts, monomeric polycarboxylic acids and hydroxycarboxylic acids and their salts, phosphates and phosphonates, and mixtures of such substances. Preferred salts of the abovementioned compounds are the ammonium and/or alkali metal salts, i.e. the lithium, sodium, and potassium salts, and particularly preferred salts is the sodium salts. Secondary builders which are organic are preferred. A polymeric polycarboxylic acid is the homopolymer of acrylic acid. Other suitable secondary builders are disclosed in WO 95/01416, to the contents of which express reference is hereby made.

Preferably the total amount of co-builder present is an amount of up to 10% by weight, preferably at least 5% by weight. The actual amount used in the compositions will depend upon the nature of the builder used.

The shaped body or detergent compositions may also comprise a source of acidity or a source of alkalinity, to obtain the desired pH, on dissolution, especially if the composition is to be used in an automatic dishwashing application. Preferred silicates are sodium silicates such as sodium disilicate, sodium metasilicate and crystalline phyllosilicates. A source of acidity may suitably be any suitable acidic compound for example a polycarboxylic acid. For example a source of alkalinity may be a carbonate or bicarbonate (such as the alkali metal or alkaline earth metal salts). A source of alkalinity may suitably be any suitable basic compound for example any salt of a strong base and a weak acid. When an alkaline composition is desired silicates are amongst the suitable sources of alkalinity.

The shaped body and detergent compositions may comprise one or more anti-corrosion agents, especially when the detergent compositions are for use in automatic dishwashing operations. These anti-corrosion agents may provide benefits against corrosion of glass and/or metal and the term encompasses agents that are intended to prevent or reduce the tarnishing of non-ferrous metals, in particular of silver and copper.

The detergent compositions may include surfactants. Surfactant may also be included in the shaped body or detergent composition and any of nonionic, anionic, cationic, amphoteric or zwitterionic surface active agents or suitable mixtures thereof may be used. Many such suitable surfactants are described in Kirk Othmer's Encyclopedia of Chemical Technology, 3rd Ed., Vol. 22, pp. 360-379, “Surfactants and Detersive Systems”, incorporated by reference herein. In general, bleach-stable surfactants are preferred according to the present invention.

Non-ionic surfactants are especially preferred according to the present invention, especially for automatic dishwashing compositions. For laundry and cleaning applications (excluding automatic dishwashing) other surfactants such as anionic surfactants are preferably included and suitable types are well known in the art.

A preferred class of nonionic surfactants is ethoxylated non-ionic surfactants prepared by the reaction of a monohydroxy alkanol or alkylphenol with 6 to 20 carbon atoms. Preferably the surfactants have at least 12 moles particularly preferred at least 16 moles, and still more preferred at least 20 moles, such as at least 25 moles of ethylene oxide per mole of alcohol or alkylphenol.

Particularly preferred non-ionic surfactants are the non-ionics from a linear chain fatty alcohol with 16-20 carbon atoms and at least 12 moles, particularly preferred at least 16 and still more preferred at least 20 moles, of ethylene oxide per mole of alcohol.

According to one embodiment of the invention, the non-ionic surfactants additionally may comprise propylene oxide units in the molecule. Preferably these PO units constitute up to 25% by weight, preferably up to 20% by weight and still more preferably up to 15% by weight of the overall molecular weight of the non-ionic surfactant.

Surfactants which are ethoxylated mono-hydroxy alkanols or alkylphenols, which additionally comprises polyoxyethylene-polyoxypropylene block copolymer units may be used. The alcohol or alkylphenol portion of such surfactants constitutes more than 30% by weight, preferably more than 50% by weight, more preferably more than 70% by weight of the overall molecular weight of the non-ionic surfactant.

Another class of suitable non-ionic surfactants includes reverse block copolymers of polyoxyethylene and polyoxypropylene and block copolymers of polyoxyethylene and polyoxypropylene initiated with trimethylolpropane. Another preferred class of nonionic surfactant can be described by the formula:

R¹O[CH₂CH(CH₃)O]_{X}[CH₂CH₂O]_{Y}[CH₂CH(OH)R²]

where R¹ represents a linear or branched chain aliphatic hydrocarbon group with 4-18 carbon atoms or mixtures thereof, R² represents a linear or branched chain aliphatic hydrocarbon rest with 2-26 carbon atoms or mixtures thereof, x is a value between 0.5 and 1.5 and y is a value of at least 15.

Another group of preferred nonionic surfactants are the end-capped polyoxyalkylated non-ionics of formula:

R¹O[CH₂CH(R³)O]_{X}[CH₂]ₖCH(OH)[CH₂]ⱼOR²

where R¹ and R² represent linear or branched chain, saturated or unsaturated, aliphatic or aromatic hydrocarbon groups with 1-30 carbon atoms, R³ represents a hydrogen atom or a methyl, ethyl, n-propyl, iso-propyl, n-butyl, 2-butyl or 2-methyl-2-butyl group, x is a value between 1 and 30 and, k and j are values between 1 and 12, preferably between 1 and 5. When the value of x is >2 each R³ in the formula above can be different. R¹ and R² are preferably linear or branched chain, saturated or unsaturated, aliphatic or aromatic hydrocarbon groups with 6-22 carbon atoms, where group with 8 to 18 carbon atoms are particularly preferred. For the group R³ H, methyl or ethyl is particularly preferred. Particularly preferred values for x are comprised between 1 and 20, preferably between 6 and 15.

As described above, in case x>2, each R³ in the formula can be different. For instance, when x=3, the group R³ could be chosen to build ethylene oxide (R³=H) or propylene oxide (R³=methyl) units which can be used in every single order for instance (PO)(EO)(EO), (EO)(PO)(EO), (EO)(EO)(PO), (EO)(EO)(EO), (PO)(EO)(PO), (PO)(PO)(EO) and (PO)(PO)(PO). The value 3 for x is only an example and bigger values can be chosen whereby a higher number of variations of (EO) or (PO) units would arise.

Particularly preferred end-capped polyoxyalkylated alcohols of the above formula are those where k=1 and j=1 originating molecules of simplified formula:

R¹O[CH₂CH(R³)O]_{X}CH₂CH(OH)CH₂OR²

The use of mixtures of different nonionic surfactants is suitable in the context of the present invention for instance mixtures of alkoxylated alcohols and hydroxy group containing alkoxylated alcohols.

Other suitable surfactants are disclosed in WO 95/01416, to the contents of which express reference is hereby made.

Preferably the non-ionic surfactants are present in the shaped body or the detergent composition in an amount of from 0.1% by weight to 20% by weight, more preferably 1% by weight to 15% by weight, such as 2% to 10% by weight based on the total weight of the detergent composition.

The detergent compositions may also include enzymes. It is preferred that the enzyme is selected from proteases, lipases, amylases, cellulases and peroxidases, with proteases and amylases, especially proteases being most preferred. It is most preferred that protease and/or amylase enzymes are included in the compositions according to the invention as such enzymes are especially effective for example in dishwashing detergent compositions. Any suitable species of these enzymes may be used as desired. More than one species may be used.

The detergent compositions may also comprise bleach additives or bleach activation catalysts The composition may preferably comprise one or more bleach activators or bleach catalysts depending upon the nature of the bleaching compound. Any suitable bleach activator may be included for example TAED if this is desired for the activation of the bleach material. Any suitable bleach catalyst may be used for example manganese acetate or dinuclear manganese complexes such as those described in EP-A-1,741,774. The organic peracids such as perbenzoic acid and peroxycarboxylic acids e.g. PAP do not require the use of a bleach activator or catalyst as these bleaches are active at relatively low temperatures such as about 30° C. and this contributes to such bleach materials being especially preferred according to the present invention.

Water may be included in the detergent composition.

The detergent compositions may also comprise a source of acidity or a source of alkalinity, to obtain the desired pH, on dissolution, especially if the composition is to be used in an automatic dishwashing application. Preferred silicates are sodium silicates such as sodium disilicate, sodium metasilicate and crystalline phyllosilicates. A source of acidity may suitably be any suitable acidic compound for example a polycarboxylic acid. For example a source of alkalinity may be a carbonate or bicarbonate (such as the alkali metal or alkaline earth metal salts). A source of alkalinity may suitably be any suitable basic compound for example any salt of a strong base and a weak acid. When an alkaline composition is desired silicates are amongst the suitable sources of alkalinity.

The detergent compositions may comprise one or more anti-corrosion agents, especially when the detergent compositions are for use in automatic dishwashing operations. These anti-corrosion agents may provide benefits against corrosion of glass and/or metal and the term encompasses agents that are intended to prevent or reduce the tarnishing of non-ferrous metals, in particular of silver and copper.

It is known to include a source of multivalent ions in detergent compositions, and in particular in automatic dishwashing compositions, for anti-corrosion benefits. For example, multivalent ions and especially zinc, bismuth and/or manganese ions have been included for their ability to inhibit such corrosion. Organic and inorganic redox-active substances which are known as suitable for use as silver/copper corrosion inhibitors are mentioned in WO 94/26860 and WO 94/26859. Suitable inorganic redox-active substances are, for example, metal salts and/or metal complexes chosen from the group consisting of zinc, bismuth, manganese, titanium, zirconium, hafnium, vanadium, cobalt and cerium salts and/or complexes, the metals being in one of the oxidation states II, III, IV, V or VI. Particularly suitable metal salts and/or metal complexes are chosen from the group consisting of MnSO₄, Mn(II) citrate, Mn(II) stearate, Mn(II) acetylacetonate, Mn(II) [1-hydroxyethane-1,1-diphosphonate], V₂O₅, V₂O₄, VO₂, TiOSO₄, K₂TiF₆, K₂ZrF₆, CoSO₄, Co(NO₃)₂, Zinc acetate, zinc sulphate and Ce(NO₃)₃. Any suitable source of multivalent ions may be used, with the source preferably being chosen from sulphates, carbonates, acetates, gluconates and metal-protein compounds. Zinc salts are specially preferred corrosion inhibitors.

Preferred silver/copper anti-corrosion agents are benzotriazole (BTA) or bis-benzotriazole and substituted derivatives thereof. Other suitable agents are organic and/or inorganic redox-active substances and paraffin oil. Benzotriazole derivatives are those compounds in which the available substitution sites on the aromatic ring are partially or completely substituted. Suitable substituents are linear or branch-chain C₁₋₂₀ alkyl groups and hydroxyl, thio, phenyl or halogen such as fluorine, chlorine, bromine and iodine. A preferred substituted benzotriazole is tolyltriazole.

Any conventional amount of the anti-corrosion agents may be included. However, it is preferred that they are present in an total amount of from 0.01% by weight to 5% by weight, preferably 0.05% by weight to 3% by weight, more preferably 0.1% by weight to 2.5% by weight, such as 0.2% by weight to 2% by weight based on the total weight.

Polymers intended to improve the cleaning performance of the detergent compositions may also be included therein. For example sulphonated polymers may be used. Preferred examples include copolymers of CH₂=CR¹—CR²R³—O—C₄H₃R⁴—SO₃X wherein R¹, R², R³, R⁴ are independently 1 to 6 carbon alkyl or hydrogen, and X is hydrogen or alkali with any suitable other monomer units including modified acrylic, fumaric, maleic, itaconic, aconitic, mesaconic, citraconic and methylenemalonic acid or their salts, maleic anhydride, acrylamide, alkylene, vinylmethyl ether, styrene and any mixtures thereof. Other suitable sulfonated monomers for incorporation in sulfonated (co)polymers are 2-acrylamido-2-methyl-1-propanesulphonic acid, 2-methacrylamido-2-methyl-1-propanesulphonic acid, 3-methacrylamido-2-hydroxy-propanesulphonic acid, allysulphonic acid, methallysulphonic acid, 2-hydroxy-3-(2-propenyloxy)propanesulphonic acid, 2-methyl-2-propenen-1-sulphonic acid, styrenesulphonic acid, vinylsulphonic acid, 3-sulphopropyl acrylate, 3-sulphopropylmethacrylate, sulphomethylacrylamide, sulphomethylmethacrylamide and water soluble salts thereof. Suitable sulphonated polymers are also described in U.S. Pat. No. 5,308,532 and in WO 2005/090541.

When a sulfonated polymer is present, it is preferably present in an amount of at least 0.1% by weight, preferably at least 0.5% by weight, more preferably at least 1% by weight, and most preferably at least 3% by weight, up to 40% by weight, preferably up to 25% by weight, more preferably up to 15% by weight, and most preferably up to 10% by weight.

The detergent composition may also comprise one or more foam control agents. Suitable foam control agents for this purpose are all those conventionally used in this field, such as, for example, silicones and their derivatives and paraffin oil. The foam control agents are preferably present in amounts of 0.5% by weight or less.

The detergent compositions may also comprise minor, conventional, amounts of preservatives.

A particularly suitable detergent gel formulation for use with the coated bleach material of the present invention is detailed below in Table 1.

TABLE 1

| Relative % | Function |
|---|---|
| 0.100 | Corrosion Inhibitor |
| 30.000 | Surfactant/Polymers |
| 54.000 | Complexing agent |
| 0.500 | Amylase Enzyme |
| 4.000 | Protease Enzyme |
| 1.000 | 1,2-Propylene glycol |
| 10.400 | Polyalkylene glycols |

Preferably the coated bleach material would comprise between 1 and 15% by weight of the detergent composition. More preferably the bleach material would comprise between 3 and 10% by weight of the detergent composition and most preferably between 5 and 8% by weight of the detergent composition.

An example of a suitable detergent powder formulation for use with the coated bleach material of the present invention is detailed below in Table 2.

TABLE 2

| Relative % | Function |
|---|---|
| 0.250 | Corrosion Inhibitor |
| 15.000 | Surfactant/Polymers |
| 12.000 | Sodium Carbonate |
| 67.250 | Complexing agent |
| 0.500 | Amylase Enzyme |
| 4.000 | Protease Enzyme |
| 1.000 | Phosphonate |

Preferably the coated bleach material would comprise between 1 and 15% by weight of the detergent composition. More preferably the bleach material would comprise between 3 and 10% by weight of the detergent composition and most preferably between 5 and 8% by weight of the detergent composition.

### EXAMPLES

The invention is further demonstrated by the following non limiting examples.

Further examples within the scope of the invention will be apparent to the person skilled in the art.

The Particles were prepared comprising;

1) 6-phthalimidoperoxyhexanoic acid (PAP) as the bleach material available as Eureco™ WM1 from Solvay Chemicals and comprising 70-75% by weight active PAP.

2) a mixture of 6-O-a-D-Glucopyranosyl-D-sorbitol (1,6-GPS) and 1-0-A-d-Glucopyranosyl-D-mannitol dehydrate (1,1-GPM) as the binder material known as ‘Isomalt’ and available from BENEO-Palatinit. (GalenIQ™ 800 is used in these examples), and

3) a soy polysaccharide as the disintegrant available as Emcosoy STS IP from J. Rettenmaier & Sohne GmbH.

TABLE 3

| | Example 1 |
|---|---|
| Raw materials | % by weight |
| 6-phthalimido-peroxyhexanoic acid | 85 |
| (PAP); Eureco ™ WM1 | |
| Isomalt (GalenIQ ™ 800) | 10 |
| Emcosoy STS IP | 5.0 |

Example 1 in table 3 was prepared by firstly mixing the bleach material and the binder material together with the disintegrant to form a powder, then adding 330 mL of water to 1600 g of the Powder. This is then mixed to form a paste, and extruded in a Glatt Extruder GBE 200. The resulting extrudate is then spheronized in a Glatt Spheronizer P50.

All percentages are by weight based on the amount of raw material used (not active weight for the PAP) and the total weight of the resultant particulate mixture.

The particles in the examples have a diameter of ˜1000 microns prior to coating.

The particles were then coated. In a particularly preferred coating this comprised:

1) A first or inner coating layer of mannitol equivalent to 13% by weight of total coated particle

2) A second or outer coating layer of polyvinyl alcohol (Mowiol 8-88 from Kuraray) The total amount of the second or outer layer is equivalent to 26% by weight of the total coated particle

In another preferred coating, the same first layer as above was used but wherein Mowiol 3-85 (Kuraray) is used for the second coating layer.

TABLE 4

| | Example 2 | Example 3 |
|---|---|---|
| Raw materials | % by weight | % by weight |
| Particle (Example 1 from table 2) | 61 | 61 |
| Mannitol (C*Mannidex, Cargill) | 13 | 13 |
| Polyvinyl alcohol (Mowiol 8-88, | 26 | |
| Kuraray)/Triethylcitrate (95:5) | | |
| Polyvinyl alcohol (Mowiol 3-85, | | 26 |
| Kuraray)/Triethylcitrate (95:5) | | |

### Stability

The particles of Example 2 were stored in the gel dishwashing detergent detailed on Table 1, for 6 weeks under different environmental conditions.

Table 5 shows the stability data for the particles of example 2.

The results show that the coated particles have exemplary stability over a 6 week period. The stability was measured by measuring the activity of the bleach material, in this case PAP, in comparison with the bleach activity of the material initially.

TABLE 5

| Storage Stability | Start | 6 weeks |
|---|---|---|
| Example 2 - PAP Activity relative | % | % |
| Storage at 40° C., 75% r.h. | 100 | 65 |
| Storage at 25° C., 50% r.h. | 100 | 96 |

Uncoated PAP particles stored under the same conditions showed no activity after 6 weeks. All of the PAP had been broken down under the storage conditions.

The particles of Example 3 were stored in the powder dishwashing detergent detailed on Table 2, for 12 weeks under different environmental conditions. Table 6 shows the stability data for the particles of example 3.

The results show that the coated particles have exemplary stability over a 12 week period. The stability was measured by measuring the activity of the bleach material, in this case PAP, in comparison with the bleach activity of the material initially.

TABLE 6

| Storage Stability | Start | 12 weeks |
|---|---|---|
| Example 2 - PAP Activity relative | % | % |
| Storage at 40° C., 75% r.h. | 100 | 77 |
| Storage at 25° C., 50% r.h. | 100 | 100 |

Uncoated PAP particles stored under the same conditions showed no activity after 6 weeks. All of the PAP had been broken down under the storage conditions.

### PAP Activity Test Method

The method described in EP 1727886 B1, paragraph 42 was used to determine the PAP activity remaining in the samples. This is an iodometric titration method.

1. A particle comprising:
a core comprising bleach material; and
at least two different coating layers;
wherein at least one coating layer comprises a sugar compound and at least one other coating layer comprises a polymer.

2. The particle according to claim 1, wherein the sugar compound is mannitol.

3. The particle according to claim 1, wherein the polymer is selected from the group consisting of polyvinyl acetate, polyvinyl alcohol and a combination thereof.

4. The particle according to claim 1 further comprising a binder.

5. The particle according to claim 4, wherein the binder comprises isomalt (6-O-α-D-Glucopyranosyl-D-sorbitol (1,6-GPS)+1-O-α-D-Glucopyranosyl-D-mannitol dehydrate (1,1-GPM)).

6. The particle according to claim 1, the core further comprising a disintegrant.

7. The particle according to claim 6, wherein the disintegrant comprises a soy saccharide.

8. The particle according to claim 1, wherein the bleach material comprises an organic peracid.

9. The particle according to claim 8, wherein the organic peracid is PAP (6-phthalimidoperhexanoic acid).

10. The particle according to claim 9, wherein the core comprises:
between 75-95% by weight of the bleach material comprising at least 60% by weight PAP;
between 2.5-15% by weight of a binder comprising isomalt; and
between 2.5-10% by weight of a disintegrant comprising a soy saccharide.

11. The particle according to claim 1, the core further comprising additives.

12. The particle according to claim 1, wherein at least one polymer coating layer further comprises additives.

13. The particle according to claim 11, wherein the additives comprise one of more of polyvinylpyrrolidone (PVP, povidone), polyvinylpyrrolidone (crospovidone), cross-linked sodium carboxymethyl cellulose (croscarmellose sodium), modified starch, sodium starch glycolate, cellulose, microcrystalline cellulose, carboxymethylcellulose, hydroxypropyl cellulose, hydroxypropylmethyl cellulose, methyl cellulose, triethyl citrate, pentaerythritols, sorbitol, mannitol, glycerine and glycols such as glycerol, ethylene glycol and polyethylene glycol.

14. The particle according to claim 12, wherein the additives are triethyl citrate (TEC) and polyvinyl pyrrolidone (PVP).

15. The particle according to claim 12, wherein the additives comprise between 5% and 30% by weight of the polymer coating layer.

16. The particle according to claim 1, wherein at least one sugar coating comprises between 5 and 40% by weight of the coated particle.

17. The particle according to claim 1, wherein at least one polymer coating layer comprises between 5 and 40% by weight of the coated particle.

18. The particle according to claim 1, wherein the particle diameter is between 200 and 20000 microns.

19. The particle according to claim 1, wherein the particle diameter is between 1000 and 5000 microns.

20. A detergent composition comprising at least one particle of claim 1.

21. The detergent composition of claim 20, wherein the composition is formulated for use in an automatic dishwashing machine.

22. The detergent composition according to claim 20, wherein the detergent composition comprises one of a gel and a liquid.

23. The detergent composition according to claim 20, wherein the detergent composition comprises a compressed tablet.

24. The detergent composition according to claim 20, wherein the detergent composition comprises one or both of a powder and granules.

25. The contained detergent composition according to claim 30, wherein the container is a flexible polyvinylalcohol (PVOH) film.

26. The contained detergent composition according to claim 30, wherein the container is a rigid polyvinylalcohol (PVOH) casing.

27. (canceled)

28. A method of making the particles of claim 1 comprising:
preparing the core; and
applying the coating layers.

29. (canceled)

30. A contained detergent composition comprising:
the detergent composition of claim 20; and
a container within which the detergent composition is contained.

31. The method of making the particles according to claim 28, wherein preparing the core comprises a preparation selected from the group consisting of granulation, compaction and extrusion and spheronization.
